(19) United States
(12) Patent Application Publication
(10) Pub. No.: US 2024/0219876 A1
(43) Pub. Date: Jul. 4, 2024

(54) SWIMMING POOL BATHER LOAD DETECTION SYSTEM AND METHOD

(71) Applicant: Pentair Water Pool and Spa, Inc., Cary, NC (US)

(72) Inventors: Azur Dzindo, Raleigh, NC (US); Mitchell Bellamy, Sanford, NC (US); Sean McEwan, Chapel Hill, NC (US); Keith Lewis, New Hill, NC (US); Anas Alhajeh, Clayton, NC (US)

(21) Appl. No.: 18/397,429

(22) Filed: Dec. 27, 2023

Related U.S. Application Data
(60) Provisional application No. 63/477,791, filed on Dec. 29, 2022.

(51) Int. Cl. G05B 19/042; E04H 4/12; G06V 20/52; G06V 40/10

(52) U.S. Cl. CPC G05B 19/042; E04H 4/1245; E04H 4/1281; G06V 20/53; G06V 40/10; G05B 2219/2605

(57) ABSTRACT

An apparatus and method for bather load detection are provided. In one instance, a method for determining bather load in a pool comprises calculating a first permeability of a membrane filter at a first period of time by measuring a pressure differential across a membrane filter located in the pool, measuring a flow rate of pool water through the fluid circuit formed by the pool, determining a volume of the membrane, calculating a second permeability of a membrane filter at a second period of time, calculating a difference between the first permeability and the second permeability, and determining a bather load based on the calculated difference between the first permeability and the second permeability.

### CROSS-REFERENCE TO RELATED APPLICATIONS

This application claims the benefit of U.S. Provisional Patent Application No. 63/477,791, filed Dec. 29, 2022, the entire disclosure of which is incorporated by reference herein.

### TECHNICAL FIELD

The present disclosure generally relates to a bather load in aquatic applications such as swimming pools or spas. More particularly, the disclosure relates to a detection system for determining a bather load in a pool where the system detects the number of bathers and adjusts one or more operating conditions of the swimming pool in response to the current or predicted bather load.

### BACKGROUND

Bather load may refer to the number of objects within aquatic applications such as swimming pools, spas, and other bodies of water. Bathers can introduce contaminants such as bodily fluids, particulates, viruses, bacteria, and other unwanted substances such as sunscreen and tanning oils into the water system. Conventional water systems may remove the contaminants with filters or neutralize the contaminants with treatment chemistries. Thus, as the bather load fluctuates, so may the needs of the system.

Typically, filters may be used to remove contaminants, such as particles from fluids passing through the filter, such as dirt, oils, and other debris. Conventional filter systems may be provided in the form of a variety of filter types. For example, a filter system may utilize sand, diatomaceous earth (DE), a cartridge, a high-efficiency filter, porous media, membranes, or combinations thereof. While each filter may have a different life span and/or operating time before maintenance is required, each filter will eventually foul with contaminants. As such, the life of the filter may be impacted by the bather load. This may be problematic when the bather load is high, for example, during a pool party. Thus, it would be beneficial to detect and/or predict when the bather load is high, or will be high, so that any maintenance can be proactively performed so that the filter can handle the increased load.

Conventional water systems also typically utilize chemical treatment systems to neutralize some contaminants. For example, chlorine may be added to the system to manage viruses and bacteria. However, in conventional water treatment systems, the chemical feed rate is usually manually set and then adjusted in response to changes in the measured water quality. As such, conventional water treatment systems are reactive. This may not address the current contaminants because it may take a long period of time for the water chemistry in the general body of water to change and therefore be observable by water quality probes. Thus, by the time the treatment system adjusts the dosage of the treatment chemistry, the water quality may have already changed again. As such, the chemical treatment system may lag behind the real-time needs of the system. The lag can result in more chemical use and decreased comfort for the bathers because the water quality may fluctuate. Also, this increased chemical consumption can put more of a burden on the water system (e.g., filtration) equipment. Thus, it would be beneficial to predict the system's chemical needs based on a more accurate determination of the bather load so that a more consistent quality of water can be maintained with fewer chemicals.

Therefore, there is a need for a bather load detection system that can detect the bather load of the system and predictively adjust one or more operating conditions of the aquatic application so that a more consistent water quality is maintained.

### SUMMARY

A bather load detection system and method are provided. In one instance, the method of predicting bather load comprises capturing a first thermal image data using an infrared camera over a first period of time, detecting a first number of bathers based on a rolling average of a pixel count from the first thermal image data, calculating a first cumulative bather load value from the first detected number of bathers, capturing second thermal image data using an infrared camera over a second period of time, detecting a second number of bathers based on a rolling average of a pixels count from the second thermal image data, and calculating a second cumulative bather load value from the second detected number of bathers. The method further includes the steps of predicting a third cumulative bather load value for a third period of time based on the first cumulative bather load, the first period of time, the second cumulative bather load value, and the second period of time, and dosing one of chlorine, an acid, or an alkaline chemical prior to the third period of time in response to the predicted third cumulative bather load value.

In another instance, the predicted third cumulative bather load value is determined using numerical methods to average a plurality of cumulative bather loads determined over a plurality of time periods.

In another instance, the predicted third cumulative bather load value is determined using machine learning to predict a plurality of cumulative bather loads over a plurality of time periods.

In another instance, the method further comprises the step of calculating a fourth cumulative bather load value over a fourth period of time by counting a detected number of RFID bracelets during the fourth period of time and comparing the fourth cumulative bather load value to the predicted third cumulative bather load value to predict a fifth bather load value over a fifth period of time.

In one instance, a method for determining bather load in a pool comprises calculating a first permeability of a membrane filter at a first period of time by measuring a pressure differential across a membrane filter located in the pool, measuring a flow rate of pool water through the fluid circuit formed by the pool, determining a volume of the membrane, calculating a second permeability of a membrane filter at a second period of time, calculating a difference between the first permeability and the second permeability, and determining a bather load based on the calculated difference between the first permeability and the second permeability.

In one instance, a fouling rate of the membrane filter is determined by tracking a temperature change of the water of the pool over a predefined time period.

### DESCRIPTION OF THE DRAWINGS

FIG. 1 is a block diagram of an exemplary aquatic system in the form of a swimming pool;

FIG. 2A is a block diagram of a pool system including a first bather load detection system;

FIG. 2B is a block diagram of a pool system including a second bather load detection system;

FIG. 2C is a block diagram of a pool system including a third bather load detection system; and

FIG. 3 is a method of controlling one or more operating parameters of a pool based on an actual or predicted bather load value according to an instance.

### DETAILED DESCRIPTION

Before any instances of the invention are explained in detail, it is to be understood that the invention is not limited in its application to the details of construction and the arrangement of components set forth in the following description or illustrated in the following drawings. The invention is capable of other instances and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use instances of the invention. Various modifications to the illustrated instances will be readily apparent to those skilled in the art, and the generic principles herein can be applied to other instances and applications without departing from instances of the invention. Thus, instances of the invention are not intended to be limited to instances shown but are to be accorded the widest scope consistent with the principles and features disclosed herein. The following detailed description is to be read with reference to the figures, in which like elements in different figures have like reference numerals. The figures, which are not necessarily to scale, depict selected instances and are not intended to limit the scope of instances of the invention. Skilled artisans will recognize the examples provided herein have many useful alternatives and fall within the scope of instances of the invention.

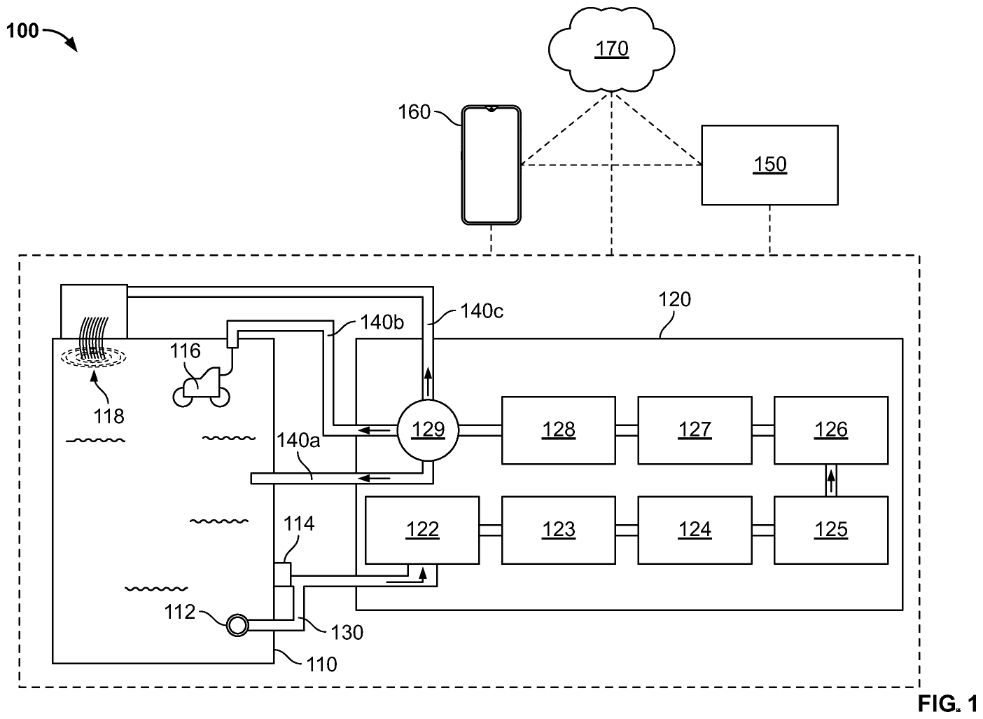

FIG. 1 illustrates an exemplary aquatic application, such as a pool or spa system 100. The pool or spa system 100 comprises a pool 110 and a pool pad 120 designed to retain one or more swimming pool 110 devices. Additionally, the system 100 may include one or more accessories, such as a robotic pool cleaner. Water may flow from the pool 110, through the pool pad 120 via an inlet pipe 130, and back to the pool 110 from the pool pad 120 via one or more outlet pipes 140a-140c. The inlet pipe 130 may permit water from the pool 110 to flow into the pool pad 120 from a drain 112 positioned in the pool 110. In some instances, the inlet pipe 130 may also permit water to flow from the pool 110 into the pool pad 120 via a skimmer 114. Thus, a fluid circuit is created.

The pool pad 120 can include one or more components in fluid communication with the pool 110. As shown, the pool pad 120 may comprise one or more of a variable speed pump 122, a booster pump 123, a filter 124, a heater 125, a sanitizer 126, a water quality monitor 127, a water chemistry regulator 128, and one or more valves 129. The one or more valves 129 may be connected to one or more outlet pipes returning the pool water to the pool 110. As shown, the system 100 comprises three outlet pipes 140a-140c. A first outlet pipe 140a functions as a return pipe. A second outlet pipe 140b is in fluid communication with a pool cleaner 116. A third outlet pipe 140c is in fluid communication with a water feature 118.

The filter 124 may be provided in the form of a sand filter, a diatomaceous earth (DE) filter, a cartridge filter, a high-efficiency filter, a hollow fiber membrane filter, a hybrid filter, or any known filter. In one instance, the filter 124 is a sand filter. Sand filters clean water by trapping contaminants in the sand as the water flows through the filter. Although sand filters are cost-effective and easy to use, they may require regular backwashing. In another instance, the filter 124 comprises a DE filter. Similar to sand filters, DE filters work by trapping contaminants in the DE media itself. However, conventionally, media may need to be added to DE filters after each backwash. In another instance, the filter 124 comprises a cartridge filter. Cartridge filters have a relatively high efficiency compared to sand and DE filters. However, cartridge filters may require frequent cleaning and replacement of parts such as the cartridge. In another instance, the filter 124 is a high-efficiency filter, such as a membrane filter, or hybrid filter comprising one or more filtration stages/methodologies. Conventionally, high-efficiency filters can remove most contaminants but also may require the most maintenance.

The sanitizer 126 and/or the water chemistry regulator 128 may each be provided in the form of a chlorine treatment system, a bromine treatment system, an ultraviolet (UV) system, an ozone system, an ionizer system, a hydrogen peroxide system, or any similar sanitizer system. As discussed above, the sanitizer 126 may be used to control and treat contaminated water in the pool 110. The sanitizer 126 may treat the pool water as it flows through the sanitizer 126. Alternatively, or in addition, the sanitizer 126 and/or the water chemistry regulator 128 can release chemical treatment compositions into the fluid circuit of the pool system 100 to chemically treat the pool water of the pool 110 to adjust the properties thereof.

The effectiveness of the filter 124 and the sanitizer 126 may depend on the flow rate of the pool water through the fluid circuit of the system 100. The longer it takes the water to complete the circuit, the longer it can take to treat the entire body of water. Thus, it may be beneficial to increase the variable speed pump 122 and/or the booster pump 123 speed at various times to increase the circulation rate of the water in the system 100. It may also be beneficial to predictively adjust the water treatment chemistry dosage or in response to changes in a bather load because bathers (e.g., an object or living being that may emit electromagnetic radiation, thermal radiation, and/or heat) may introduce and/or increase the amount of contaminates into the pool water.

Still referring to FIG. 1, the system 100 may further include a central controller 150 and a user device 160 that can interface with the controller 150 either directly over a local area network or via a cloud network 170. The user device 160 may be provided in the form of a mobile phone, tablet, laptop, or other suitable device with or without an application, and/or a display. The user device 160 may be designed to output or display representations of thermal images (discussed herein) from a thermal imaging device (e.g., a thermal sensor). Although FIG. 1 depicts the controller 150 in communication with the user device 160 and the cloud network 170, it should be noted that various communication methodologies and connections may be implemented to work in conjunction with, or independent from, one or more local controllers (not shown) associated with one or more individual components associated with the pool or spa system 100 (e.g., a pump controller, a heater controller, etc.). It is to be understood that the pool 110 and the pool pad 120 may comprise more or fewer components in a variety of arrangements depending on the instance.

The above examples illustrate some of the reasons why bather load may impact the timing and accuracy of maintaining water quality. Because each system may include more or fewer components than the system 100, bather loads may impact different systems and/or the devices of the systems in unique ways. Thus, by determining (e.g., calculating) or knowing a current bather load value and/or being able to predict a future bather load value, the system can be configured to proactively or automatically adjust one or more operating parameters such as treatment chemistry dosage, pump speed, filtration time, and/or scheduled maintenance. Also knowing the current bather load value and/or being able to predict a future bather load value may facilitate adjusting the operating parameters of at least one pool device or at least one pool accessory based on a bather load determination.

For example, once a bather load determination has been made or predicted, the controller 150 of the system 100 can implement one or more operations such as turning a light of the pool on and/or off at different times of day, turning water features on and/or off, sending a robotic pool cleaner to its base, turning the heater 125 on and/or off or adjusting settings of the heater 125, turning music speakers and other entertainment devices on and/of off, tracking speed and body temperature of at least one bather when the bather is moving (e.g., exercising), or recording and/or storing such tracked information. The system 100 may also automatically switch operating parameters of or between the pool devices. For example, if a bather load is detected or predicted in the spa, the system 100 may detect bathers in the spa rather than detecting bathers in the pool. Thus, the following discussion focuses on instances directed to bather load detection systems capable of measuring and/or predicting a bather load.

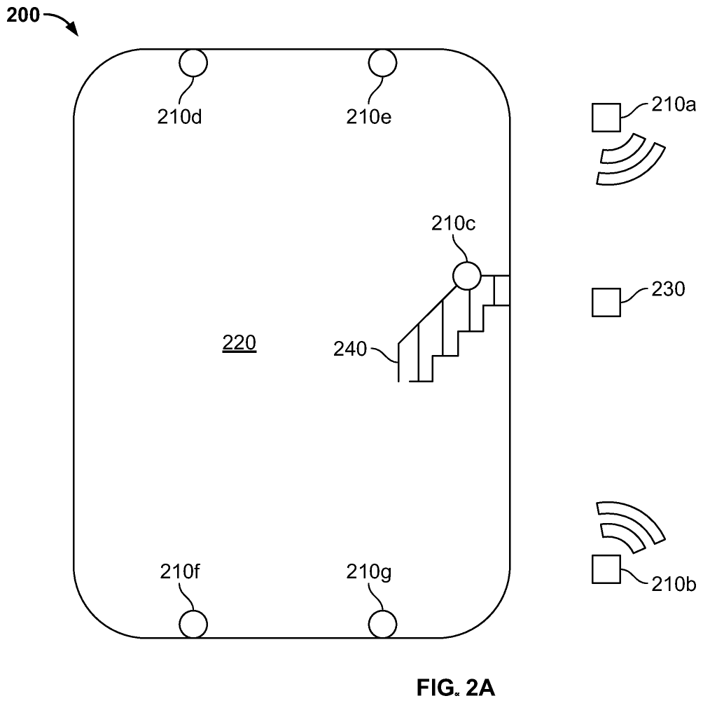

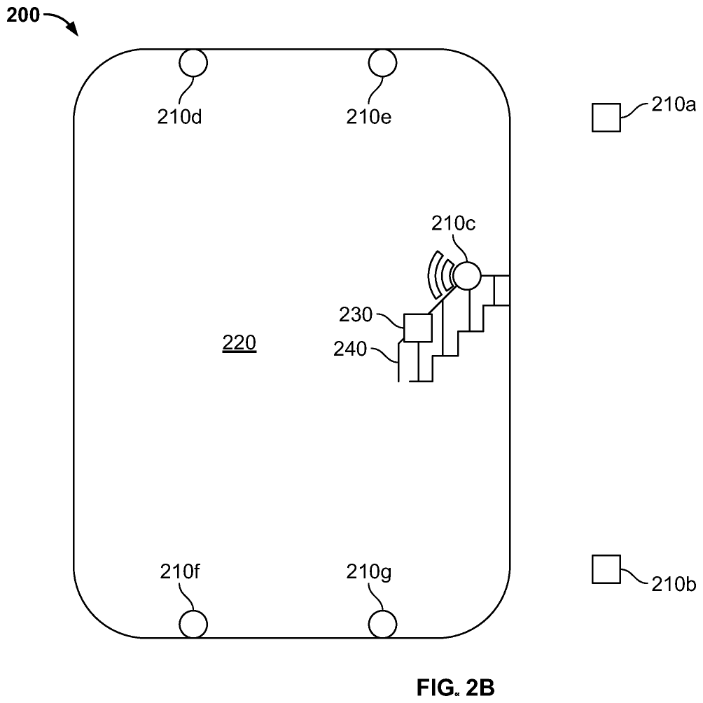

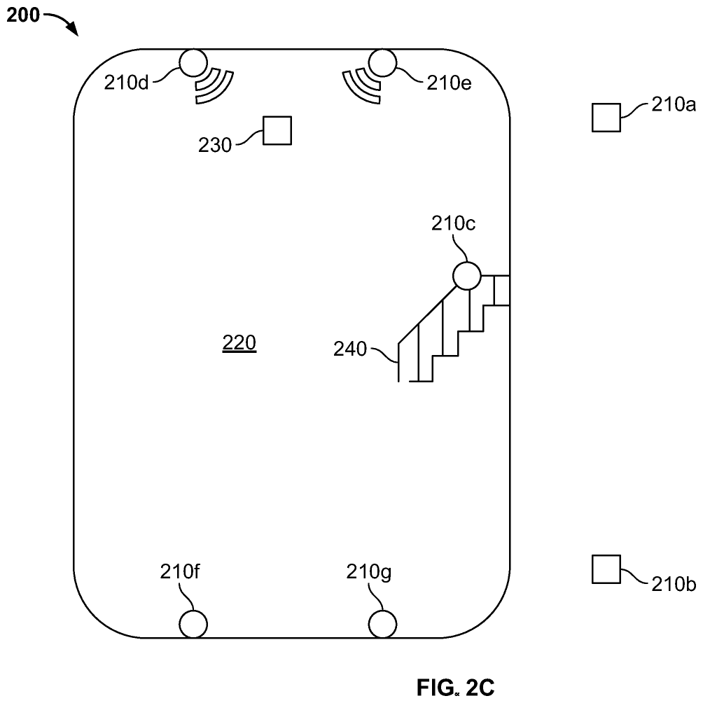

Turning to FIGS. 2A, 2B, and 2C, various instances of a bather load detection system are shown. As discussed above, pool systems may each have unique components and maintenance needs. However, it may be difficult to maintain a consistent water quality, especially when the bather load fluctuates. Therefore, by detecting bather load through one or more devices and/or sensors in or near the pool, the system can anticipate the pool's needs and adjust one or more operating parameters to proactively manage the water quality.

As shown in FIGS. 2A-C, a pool area 200 may include at least one sensor 210a-210g, collectively referred to as the sensors 210, positioned in or near a pool 220. The pool 220 may be the pool 110 of FIG. 1. As such, the pool area 200 can include one or more of the swimming pool devices (e.g., robotic pool cleaner) and/or pool pad components of the system 100 of FIG. 1.

As shown in FIG. 2A, as at least one bather 230 approaches the pool 220, a first sensor 210a and/or a second sensor 210b may detect the at least one bather 230. In one instance, the first sensor 210a and the second sensor 210b may be positioned outside of the pool 220, such as on the pool pad 120 of FIG. 1 or on a walkway near the pool 220, or in a pool accessory, such as a pool cleaner.

In one instance, as illustrated in FIG. 2B, a third sensor 210c may be positioned on or located within an entryway of the pool, such as a ladder or stairwell 240 so that the bather 230 can be detected as they enter the pool 220.

In yet another instance, as shown in FIG. 2C, the pool 220 can include one or more sensors 210d-210g. For example, the sensors 210d-210g may be incorporated into one or more lights, speakers, and/or drains of the pool 220. Further, the sensors 210d-210g may be positioned around the perimeter of the pool and/or in one of the pool walls and/or on the bottom of the pool. As illustrated, the pool 220 includes a fourth sensor 210d, a fifth sensor 210e, a sixth sensor 210f, and/or a seventh sensor 210g positioned at various points around the perimeter of the pool 220 to detect the bather 230 once the bather is in the pool. It is to be understood that the above instances are merely exemplary. The pool area 200 may include more or fewer sensors 210 depending on the instance. It is to be further understood that the sensors 210 may be positioned at different locations in or around the pool area 200.

Each of the sensors 210 may be provided in the form of a thermal imaging sensor or a thermal imaging device such as an infrared (IR) temperature sensor, a camera (e.g., infrared camera), a pressure sensor, a proximity sensor such as a radio-frequency identification (RFID) sensor, a sonar sensor, a motion detection sensor such as a light curtain sensor or an IR beam, a noise sensor such as a microphone, a touch sensor, a volume displacement sensor such as a capacitance or resistive sensor, a contamination sensor, and/or any other sensor.

In one instance, the sensors 210 are provided in the form of thermal imaging sensors. The sensors 210 may detect and/or follow the thermal image of the at least one bather 230 for the duration of their swim experience using an imaging analysis algorithm. For example, the sensor 210 may be in communication with the controller 150 while the bather is within the limits (e.g., boundary or perimeter) of the pool 110. Thermal imaging sensors also may detect high levels of contaminants that can emit heat over a predetermined threshold, such as urine or sweat.

In one instance, the sensors 210 are provided in the form of RFID sensors. The sensors 210 can detect a bather 230 based on an RFID tag. The RFID tag may be included in a wearable smart device such as a smartwatch, bracelet, or swimwear worn by or positioned near the bather 230.

In one instance, the sensors 210 are provided in the form of microphones. One or more sensors 210 positioned outside the pool 220 can detect a bather 230 based on noise levels that are different from background noises such as music, wind, mowing, animals, etc. One or more sensors 210 positioned in the pool 220 can detect a bather 230 based on noise levels under the water or in the water, such as splashing. Further, the activity level of the bather 230 can be detected based on the intensity of the noise level. For example, more bathers 239 may increase the intensity of the noise level.

In one instance, the sensors 210 are provided in the form of motion sensors. For example, the sensors 210 can be a wave or splash sensor included in the pool 220 designed to detect water movement in the pool 220. The amount of movement detected can indicate the level of activity in the pool or the number of bathers. For example, the amount of movement may increase when additional bathers 230 enter the pool 220.

In one instance, the sensors 210 are provided in the form of filter sensors. The filter sensor may be apart and separate from the filter 124 of FIG. 1. The filter sensor can include one or more of a membrane, a pressure sensor, a flow meter, or a temperature sensor. The membrane can be located close to the body of the pool 220 such as in a weir or the skimmer 114 of FIG. 1. The pressure sensor can be provided in the form of a piezo-electric sensor that can measure the pressure differential on an inlet and outlet side of the membrane. For example, a change in the pressure differential may indicate the membrane is loaded with organics, which may indicate bathers in the pool 220. In one example, the flow meter can be positioned anywhere in the pool 220 or included in a pool pad, such as the pool pad 120 of FIG. 1, to detect the flow of fluid (e.g., water) within the system 100. Similarly, in one example, the temperature sensor may be positioned anywhere in the pool 220, included in a pool pad, such as the pool pad 120 of FIG. 1, to measure temperature. Using the pressure differential, the flow rate, and the volume of the membrane, the permeability of the membrane can be determined. Because the membrane is located close to the body of the pool 220, it may become fouled faster than the filter 124 of FIG. 1. Therefore, it can be used as an early indication of higher filter loading. Moreover, the temperature sensor can be used to predict bacteria levels in the pool 220 because bacteria generally grow more rapidly in higher temperatures.

In one instance, the sensors 210 are provided in the form of safety sensors. In addition to detecting a bather 230 as disclosed herein, the sensors 210 may function as a safety alarm when a bather 230 is detected within or near the perimeter of the boundary of the pool 220. In one instance, the sensor 210 can alert a homeowner when a bather 230 is in or near the pool 220 at a time when no bathers are expected. For example, the system may include predetermined pool hours and when a bather 230 is in or near the pool 220 outside the predetermined pool hours, the safety alarm is triggered. The sensors 210 can include an audible alarm, a visual alarm, and/or a digital alarm that may be communicated to a user device, such as the user device 160 of FIG. 1.

The above examples are exemplary instances and are not intended to be an exhaustive list. It is to be understood that any of the instances disclosed herein may be combined. For example, there may be more or fewer sensors 210 as described herein, and each of the sensors 210 may be provided in a different form. Further, the sensors 210 may be integrated with one or more components already included in the area 200, such as the pool pad 120 of FIG. 1, a light, a swimming pool device such as a speaker, a handrail, a skimmer basket, a floating chemical dispensing system, a robotic pool cleaner, or any other swimming pool device or component.

Turning back to FIG. 1, the sensors 210 can be communicatively coupled to the controller 150 and/or the user device 160 over the network 170. The controller 150 may also be in communication with the user device 160 over the network 170. As such, information about the detected or predicted bather load can be communicated to the controller 150 and/or the user device 160 for analysis and/or display.

The controller 150 may be configured to track and store bather load data and values and/or upload the bather load data to a network. The network may be the network 170 or may be provided as a separate network (not shown) in communication with the network 170. The bather load data may be provided in the form of one or more of the number of bathers, the approximate size of the bathers, the approximate age of the bathers, the estimated activity level of the bathers, the amount of time the bathers are in the pool, and the like. Therefore, using the bather load data, the controller 150 can determine how to effectively manage the water quality of the pool.

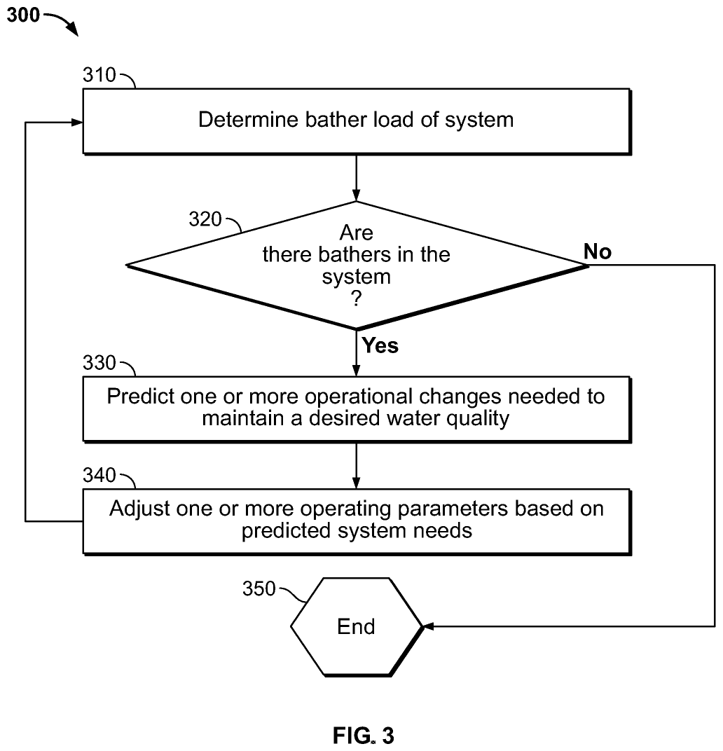

FIG. 3 illustrates a method of how the central controller 150 may utilize the bather load data to proactively manage the water quality of the pool by adjusting one or more operating parameters in response to the bather load data.

At block 310, the controller 150 determines a bather load of the system. As shown in FIG. 1, and described above, the controller 150 may be in communication with one or more components of the system 100, which may include one or more sensors, such as the sensors 210 of FIGS. 2A-2C. Thus, the controller 150 can determine the bather load by receiving and analyzing information from the sensors 210. The bather load can be provided in the form of a numerical number of individual bathers 230 taken at a snapshot in time, an average number of bathers 230 detected over a set period of time, a bather load index, wherein the bather load index is a value corresponding to an approximate bather load mass, or any other metric to quantify a count of bathers 230. The controller 150 also may store the data from the sensors 210.

At block 320, if the controller 150 determines there are no bathers 230 in the system, the method ends at block 350. However, if at block 320 the controller 150 determines there are bathers 230 in the system 100, the method proceeds to block 330. If there are no bathers 230 in the system 100, the system 100 may restart the method 300 at various intervals (e.g., 1 hour, 12 hours, 1 day, 1 week, 1 month, etc).

At block 330, the controller 150 predicts the needs of one or more components associated with the system 100 based on the bather load. As discussed above, bather loads can impact the level of contaminants in the pool 110. However, conventional water quality sensors may lag behind the needs of the system 100. Therefore, by using the bather load to predict the needs of the system 100, a more consistent water quality may be achieved. To maintain the water quality with an increased bather load, the controller 150 may determine that one or more of a pump flow rate, a chemical dosage rate, or another operating parameter should be adjusted (e.g., increased), and/or combinations thereof.

At block 340, the controller 150 sends instructions to one or more components of the system 100 such as the variable speed pump 122, the booster pump 123, the filter 124, the heater 125, the sanitizer 126, the water quality monitor 127, the water chemistry regulator 128, the one or more valves 129, and/or any other component or swimming pool device of the system 100.

In one instance, the controller 150 communicates instructions to one or more of the variable speed pump 122 and the booster pump 123 to increase the pump speed. By increasing the pump speed, the circulation rate of the pool water throughout the system can be increased, which increases the filter rate and/or the distribution of water treatment chemistries. Although increasing the filter rate of the system 100 may increase filter fouling, it may be necessary to maintain a desired water quality. However, as discussed below, the bather load can be used to determine an optimal time period for maintenance, such as backwashing the filter, so that the filter can handle increased filter loading during periods of high bather load.

In one instance, the controller 150 communicates instructions to one or more of the sanitizer 126 and the water chemistry regulator 128 to adjust one or more chemical dosage rates based on the bather load. As discussed above, it may take a longer time for the water quality monitor 127 to detect higher levels of contaminants because it may take a relatively long time for the contaminated water to reach the water quality monitor 127. Thus, by proactively or automatically adjusting the chemical dosage (e.g., via the sanitizer 127 and/or the water chemistry regulator 128) based on the bather load, the treatment chemistries used to neutralize the contaminants may already be in the pool water and can be effective more quickly.

After making one or more changes to the system 100, the sensors 210 and the controller 150 can continue to monitor the bather load of the system. Thus, after block 340, the method may return to block 310 and continue the process until no bathers 230 are detected. When no bathers 230 are detected, the controller 150 may communicate instructions to the system 100 to return to a steady or predetermined state of operation and/or return to controlling the system 100 based on conventional methods.

Further, the controller 150 and/or the network 170 may store the bather load data. In one instance, the controller 150 utilizes machine learning to interpret and/or analyze the stored data to recognize patterns and predict bather load during certain periods. For example, the controller 150 may predict a period of high bather load on an upcoming weekend during the summer based on bather load data from previous weekends or previous summers, and therefore, the controller 150 can adjust the chemicals being distributed into the pool water prior to the predicted period of high bather load. Also, the controller 150 can further determine an optimal time to perform maintenance and/or re-order chemical supplies so that the system 100 is ready for the predicted increased bather load. Moreover, the controller 150 may include an encrypted formula or encrypted response plan to treat unexpected incidents (e.g., urine disseminated into the water) or an unprecedented bather load.

Still further, in addition to proactively managing water quality, the controller 150 can trigger one or more actions according to the preferences of the bather 230. The preferences can be stored in a memory device of the controller 150, on a cloud network, such as the network 170, or an application of the user device 160. The preferences can include one or more of a favored or particular water temperature, a chlorine level, a pool light color, a water feature operational state, or any other system parameter. Thus, when a bather 230 is detected, the controller 150 can access the bather's preferences and send instructions to the system 100 to change one or more operating parameters based on the preferences.

In one instance, the controller 150 utilizes machine learning to learn and predict a particular bather's 230 preferences and/or patterns. For example, a first bather “A” may have a first set of preferences, and a second bather “B” may have a different second set of preferences. The controller 150 can predict a first time period when the first bather A will be in the pool 110 and proactively adjust the system 100 according to their preferences and can predict a second time period when the second bather B will be in the pool 110 and proactively adjust the system 100 according to their preferences.

It will be appreciated by those skilled in the art that while the invention has been described above in connection with particular instances and examples, the invention is not necessarily so limited, and that numerous other instances, examples, uses, modifications and departures from the instances, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A bather load detection system for a swimming pool system having a pool and at least one pool device, the bather load detection system comprising:
a data capture device associated with the pool system designed to capture at least one image; and
a controller communicatively coupled to the data capture device, the controller designed to:
detect one or more bathers based on the at least one image;
determine a bather load based on the one or more detected bathers;
predict at least one operational change for the at least one pool device based on the bather load; and
provide instructions to the at least one pool device of the pool system to change at least one operational parameter of the at least one pool device based on the predicted operational change.

2. A bather load detection system of claim 1, wherein the data capture device has at least one sensor that is provided in the form of a thermal imaging sensor, an infrared temperature sensor, a camera, a pressure sensor, a proximity sensor, an RFID sensor, a sonar sensor, a motion detection sensor, a light curtain sensor, a noise sensor, a touch sensor, or a volume displacement sensor.

3. A bather load detection system of claim 1, wherein the at least one pool device is a variable speed pump or a booster pump, and further wherein the controller is designed to provide the instructions to the variable speed pump or the booster pump to increase the pump speed based on the bather load.

4. A bather load detection system of claim 1, wherein the at least one pool device is at least one of a sanitizer, a water quality monitor, or a water chemistry regulator.

5. A bather load detection system of claim 4, wherein the water quality monitor is designed to measure at least one chemical within the pool system at a first time period after instructions are provided to the at least one pool device.

6. A bather load detection system of claim 5, wherein the water quality monitor is designed to measure the at least one chemical within the pool system at a second time period subsequent to the first time period, and the controller is designed to compare the measured chemical at the first time period to the measured chemical at the second time period.

7. A method of operating a pool system having a pool and at least one pool device, the method comprising:
capturing thermal image data from the pool using an infrared camera;
determining a bather load based on the thermal image data;
predicting a change to at least one operational parameter of the at least one pool device based on the bather load; and
adjusting the at least one operational parameter of the at least one pool device to maintain a desired quality of water in the pool.

8. The method of claim 7, wherein the infrared camera is provided in the form of an infrared sensor of a robotic pool cleaner.

9. The method of claim 7, wherein the infrared camera is provided in the form of an infrared sensor positioned within at least one of a light of the pool or a drain of the pool.

10. The method of claim 7, wherein the thermal image data is provided in the form of a rolling average of a pixel count.

11. The method of claim 7, further comprising providing a controller to receive the thermal image data and predict the change in the at least one operational parameter based on the data.

12. The method of claim 11, further comprising storing the thermal image data from the infrared camera in a memory of the controller.

13. The method of claim 12, wherein predicting the change to the at least one operational parameter of the at least one pool device includes analyzing the stored data within the memory of the controller.

14. The method of claim 13, wherein the controller is designed to communicate with a user device, and the user device is configured to display at least one of the thermal image data or at least one operational parameter of the at least one pool device.

15. A method for predicting bather load in a pool, the method comprising:
capturing a first thermal image using an infrared camera over a first period of time;
detecting a first number of bathers based on a rolling average of a pixel count from the first thermal image;
calculating a first cumulative bather load value from the first detected number of bathers;
capturing a second thermal image using the infrared camera over a second period of time;
detecting a second number of bathers based on a rolling average of the pixel count from the second thermal image;
calculating a second cumulative bather load value from the second detected number of bathers;
predicting a third cumulative bather load value for a third period of time based on at least one of the first cumulative bather load value, the first period of time, the second cumulative bather load value, or the second period of time; and
dosing the pool with at least one of chlorine, an acid, or an alkaline chemical prior to the third period of time in response to the predicted third cumulative bather load value.

16. The method of claim 15, wherein the predicted third cumulative bather load value is determined using numerical methods to average the first cumulative bather load and the second cumulative bather load determined over at least one of the first period of time and the second period of time.

17. The method of claim 15, wherein the predicted third cumulative bather load value is determined using machine learning to predict a plurality of cumulative bather loads over a plurality of time periods.

18. The method of claim 15, further comprising calculating a fourth cumulative bather load value over a fourth period of time by counting a detected number of RFID sensors during the fourth period of time and comparing the fourth cumulative bather load value to the predicted third cumulative bather load value to predict a fifth bather load value over a fifth period of time.

19. The method of claim 15, wherein at least one bather emits heat that is detected by the infrared camera.

20. The method of claim 15, wherein dosing the pool includes calculating an amount of the at least one of the chlorine, the acid, or the alkaline chemical to distribute into the pool based on at least one preference of a user.
